(19) United States
(12) Patent Application Publication
(10) Pub. No.: US 2013/0167641 A1
(43) Pub. Date: Jul. 4, 2013

(54) MEMS ACCELERATION SENSOR

(71) Applicant: MAXIM INTEGRATED PRODUCTS, INC., San Jose, CA (US)

(72) Inventor: Martin Heller, San Jose, CA (US)

(73) Assignee: MAXIM INTEGRATED PRODUCTS, INC., San Jose, CA (US)

(21) Appl. No.: 13/720,447

(22) Filed: Dec. 19, 2012

(30) Foreign Application Priority Data
Dec. 28, 2011 (DE) 10 2011 057 110.8

(51) Int. Cl. G01P 15/08

(52) U.S. Cl. CPC G01P 15/0802
USPC 73/514.01

(57) ABSTRACT

The present invention relates to a MEMS acceleration sensor comprising a substrate and a sensor mass that is disposed parallel to the substrate in an X-Y plane. The sensor mass is rotatable about a rotary axis, and includes a plurality of holes. The weight of the sensor mass is different on the two sides of the rotary axis. The sensor further includes sensor elements for detecting a rotary motion of the sensor mass about the rotary axis. To change the weight of the sensor mass on one side of the rotary axis relative to the other side, material of the sensor mass is partially removed in some of the holes for reducing the weight of the sensor mass, and/or material of the sensor mass is added in the Z-direction, in particular in the extension of the holes, for increasing the weight of the sensor mass.

### CROSS REFERENCE TO RELATED APPLICATIONS

The application claims the benefit of German Application Serial No. 10 2011 057 110.8, entitled “MEMS-Beschleunigungssensor”, filed on Dec. 28, 2011, the subject matter of which is incorporated herein by reference.

### BACKGROUND

A. Technical Field

The present invention relates to an MEMS acceleration sensor having a substrate and a sensor mass disposed parallel to the substrate in an X-Y plane, wherein the sensor mass is attached to the substrate rotatably about an axis, the sensor mass comprises a plurality of holes, and the weight of the sensor mass is different on the two sides of the rotary axis, and having sensor elements for detecting a rotary motion of the sensor mass about the rotary axis thereof.

B. Background of the Invention

An acceleration sensor is known from US 2010/0024554 A1, implemented as a microelectricalmechanical system (MEMS). The sensor comprises a substrate and a sensor mass disposed parallel to the substrate in an X-Y plane. The sensor mass is attached to the substrate rotatably about an axis. In order to be able to implement the weight of the sensor mass differently on the two sides of the rotary axis, an additional mass is added to the sensor mass on one side of the rotary axis within the X-Y plane. The sensor mass thereby extends further away from the rotary axis on said side than on the other side. An imbalance thereby arises between the two sides of the rotary axis, whereby an acceleration in the Z-direction can be detected, in that the sensor mass tilts about the rotary axis in case of an acceleration in the Z-direction. Sensor elements that can determine the rotary motion of the sensor are disposed between the substrate and the sensor mass, in that the distance between the sensor elements changes and a different electrical signal is thereby generated. A disadvantage of said embodiment is that a relatively large space is required for the sensor mass on the substrate in order to be able to receive the additional mass in the X-Y plane.

An acceleration sensor is known from US 2009/0031809 A1, also comprising a sensor mass that can rotate about a rotary axis. A plurality of holes are disposed in the sensor mass, partially due to the production of the sensor mass, and for reducing the weight of the sensor mass. In order to implement the sensor mass having different weights on the two sides of the rotary axis, according to the invention, a different number or size of holes is disposed in the sensor mass on the two sides of the rotary axis. Although here the same area is required on the substrate on both sides of the sensor mass, an imbalance is nevertheless produced on the two sides of the rotary axis. A disadvantage thereby, however, is that the electrodes of the sensor elements attached to the substrate and disposed on the bottom side of the sensor mass also comprise a different base capacitance due to the resulting different areas due to the different holes in the two halves of the sensor mass.

### SUMMARY OF THE INVENTION

The object of the present invention is thus to produce an MEMS acceleration sensor comprising a low required area on the substrate and nevertheless allowing reliable detection of an acceleration of the substrate or sensor.

The object is achieved by means of an MEMS acceleration sensor having the characteristics of the independent claim 1.

An MEMS acceleration sensor according to the invention comprises a substrate and a sensor mass disposed parallel to the substrate in an X-Y plane. The sensor mass is attached to the substrate rotatably about an axis. A plurality of holes are disposed in the sensor mass. In order to be able to detect an acceleration perpendicular to the rotary axis, the weight of the sensor mass is implemented so as to be different on the two sides of the rotary axis. Sensor elements suitable for detecting a rotary motion of the sensor mass about the rotary axis thereof are further provided. Said sensor elements are typically plate electrodes of a capacitive sensor. One electrode thereof is attached to the substrate, while the other electrode, disposed opposite thereof, is attached on the bottom side of the sensor mass. A rotary motion of the sensor mass about the rotary axis thereof causes the two electrodes of the sensor elements either to separate away from each other or to move toward each other. A change in the electrical signal is thereby generated, from which the distance of the electrodes from each other and thus the rotary motion of the sensor mass about the rotary axis thereof can be determined.

In order to change the weight of the sensor mass on one side of the rotary axis relative to the other side of the rotary axis, changes to the mass of the sensor mass are made on one side of the rotary axis relative to the other side of the rotary axis. To this end, material of the sensor mass is partially removed in the region of some of the holes for reducing the weight of the sensor mass. Additionally or alternatively, material can also be added to the sensor mass for increasing the weight of the sensor mass. To this end, according to the invention, said additional material as seen in the Z-direction is added particularly in the extension of the holes. The added material of the sensor mass can also take place in a region in which no holes are disposed.

The critical point of all of these inventive measures is that the thickness of the material of the sensor mass is changed in order to produce a different weight of the sensor mass on one side of the rotary axis as compared to the other side of the rotary axis. The holes on one side can be expanded, that is, material of the sensor mass is removed in the vicinity or region of the holes. It is also possible to add material to the sensor mass on the other side. To this end, the material of the sensor mass is implemented to be thicker in the intended region than in the remainder of the sensor mass. There are thus thicker and thinner zones in the region of the sensor mass, distributed across the sensor mass so that a different mass distribution is present on the two sides of the rotary axis. Production of such differences in thickness of the sensor mass can be done by etching the sensor mass, for which different masks or sandwich masks are used, for example, in order to obtain individual height variances of the sensor mass.

Substantial advantages of the present invention are the potential for producing an imbalance of the sensor mass on the two sides of the rotary axis of the sensor mass in a relatively small area of the sensor mass in the X-Y plane, whereby the acceleration sensor can detect accelerations in the Z-direction. In an advantageous embodiment of the invention, the material of the sensor mass can also be affected on both sides of the rotary axis, so that the bottom sides of the sensor mass on both sides of the rotary axis are preferably identical. The sensor elements can thereby detect identical signals on both sides of the rotary axis of the sensor mass in an initial state. This is the case because electrodes of the sensor elements attached to the sensor mass can be implemented identically on both sides of the rotary axis, and comprise the same spacing from electrodes attached to the substrate.

In a further advantageous embodiment of the invention, the rotary axis of the sensor mass is disposed symmetrically with respect to a projection area of the sensor mass. This means that the area required by the sensor is identical on both sides of the rotary axis. The result is the least possible area required for the acceleration sensor. The invention is not, however, limited to a symmetrical implementation of the projection surface of the sensor mass with respect to the rotary axis. In addition to the measures according to the invention for affecting the material thickness of the sensor mass, an asymmetry of the projection surface may also be present, such as by adding additional material within the X-Y plane, in order to produce a further imbalance.

In a particularly advantageous embodiment of the invention, the holes are implemented as through holes. This makes the sensor mass easier to produce using conventional methods and incidentally reduces the weight of the sensor mass.

As a variant of the invention, the holes are advantageously stepped. This means that the holes are, for example, cylindrical, rectangular, or square, wherein the inner diameter at the start of the hole is greater than at the end of the hole. The greater hole diameter is preferably located on the side of the sensor mass facing away from the substrate.

As an alternative, it is also possible that the holes are conical in design. Here again it is advantageous that the greater diameter of the conical hole is located on the side of the sensor mass facing away from the substrate. This makes production easier.

If the material of the sensor mass is at least partially removed on one side of the rotary axis in order to generate a thinner wall of the sensor mass, then normally thick and thinner regions are produced in the sensor mass. The thinner regions of the sensor mass, which can extend over the entire width of the sensor mass in the Y-direction or over the entire length of the sensor mass on one side in the X-direction, reduce the weight of the sensor mass of one side significantly, compared to the weight of the sensor mass on the opposite side of the rotary axis.

In order to increase the weight of the sensor mass, it can also be provided that the material is added at least partially to the sensor mass, in order to produce a thicker wall of the sensor mass relative to the normal thickness of the sensor mass. The protrusions thus produced on the sensor mass can extend in regions over the entire width in the Y-direction and/or length in the X-direction of a side.

A very particular advantage of the invention is achieved in that the material is removed or added on the side of the sensor mass facing away from the sensor elements. The design of the sensor mass on the bottom side thereof, that is, on the side facing the substrate, is thereby not changed. The bottom side of the sensor mass accordingly has the same design on both sides of the rotary axis. The detection of the rotary motion about the rotary axis by the electrodes is thereby made significantly easier, because both sides output an identical signal in the zero position. The surfaces can be the same size and be used identically for mounting the sensor elements. The change in material, and thereby in weight, of the sensor mass takes place only on the side of the sensor mass that has no sensor elements, as seen in the Z-direction.

In a further advantageous embodiment of the invention, the material is removed or added outside of the region of the sensor mass in which the sensor elements are disposed. Detection of the rotary motion by the sensor elements is not affected by the fact that the change to the material, and thus to the weight, of the sensor mass is implemented on both sides of the rotary axis, independently of the sensor elements.

The acceleration sensor according to the invention is particularly advantageously applicable if the sensor mass is mounted for rotations into and/or out of the X-Y plane. Accelerations in the Z-direction as well as in the X-direction and Y-direction can thereby be detected.

An MEMS acceleration sensor according to the invention can also be implemented such that a plurality of sensor masses are provided for detecting accelerations in a plurality of directions. The present sensor can thus be used as a 1D, 2D, or 3D sensor.

### BRIEF DESCRIPTION OF THE DRAWINGS

Further advantages of the invention are described in the following exemplary embodiments. There is showing:

FIG. 1 the plan view of an MEMS acceleration sensor,

FIG. 2 a side view of FIG. 1,

FIG. 3 a detail of the MEMS acceleration sensor from FIG. 1,

FIG. 4 a further exemplary embodiment in plan view of an MEMS acceleration sensor,

FIG. 5 a side view of FIG. 4 of the MEMS acceleration sensor,

FIG. 6 a further exemplary embodiment of an MEMS acceleration sensor in a plan view,

FIG. 7 a detail of FIG. 6,

FIG. 8 a detail of a cross section of an MEMS acceleration sensor from FIG. 6, and

FIG. 9 an alternative to the embodiment of FIG. 8.

### DETAILED DESCRIPTION OF THE PREFERRED EMBODIMENTS

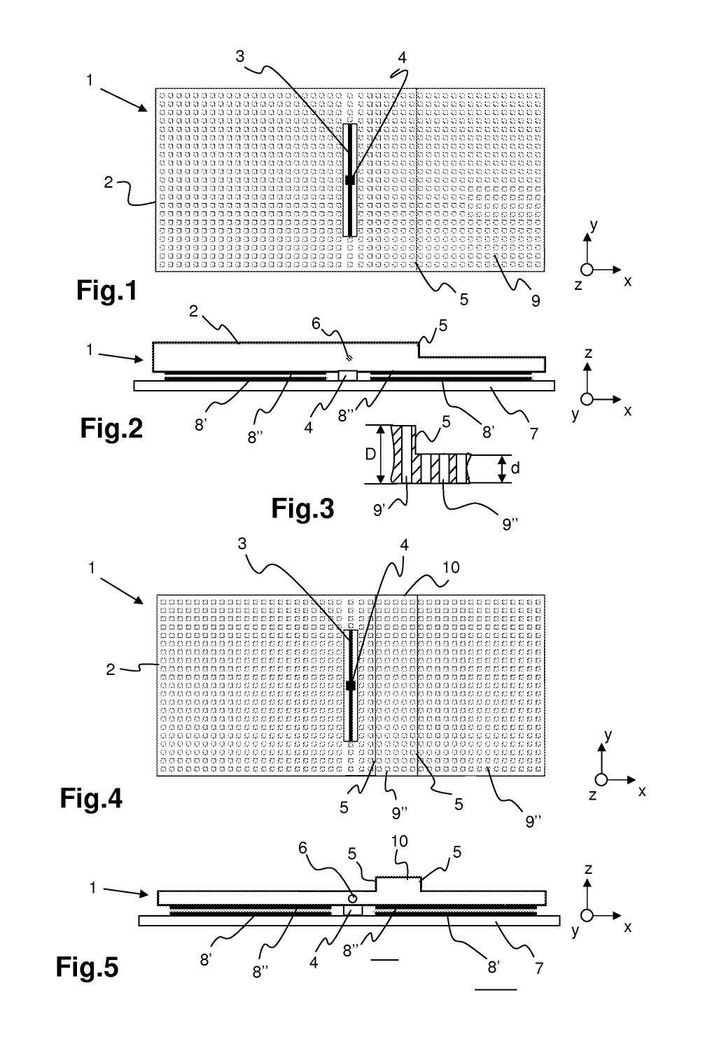

FIG. 1 shows a plan view of an acceleration sensor 1 according to the invention as a sketch. The MEMS acceleration sensor 1 comprises a sensor mass 2 having a rectangular projection surface. The sensor mass 2 extends in an X-Y plane. A torsional spring 3 is attached in the direction of the Y-axis, by means of which the sensor mass 2 is mounted on an anchor 4. The torsional spring 3 extends along the Y-axis or rotary axis of the sensor mass 2. If an acceleration occurs in the direction of the Z-axis protruding out of the plane of the drawing, then the sensor mass 2 is rotated about the rotary axis 6 or Y-axis. The reason for this is that the mass distribution is different on the two sides of the Y-axis of the sensor mass 2. To the right of the Y-axis, the sensor mass 2 has an offset 5. The thickness of the sensor mass 2 is reduced, starting from the offset 5. The total mass of the sensor mass 2 to the right of the Y-axis is thereby less than that to the left of the same. For an acceleration in the Z-direction, therefore, a torque will arise that is greater on the left side than on the right side of the Y-axis. Accordingly, the sensor mass 2 will tend to tip toward the left side instead of the right side of the rotary axis Y.

FIG. 2 shows a side view of the acceleration sensor 1 from FIG. 1 as a sketch. The sensor mass 2 is attached to a substrate 7 by means of the anchor 4 and the spring 3, not shown here. The sensor mass 2 rotates about the rotary axis 6 extending in the direction of the Y-axis. A first sensor electrode 8′ is attached to the substrate. A second sensor electrode 8″ is disposed opposite said sensor electrode 8′ on the underside of the sensor mass 2. The two sensor electrodes 8′ and 8″ generate an electrical signal as a function of the distance between them. For a rotary motion of the sensor mass 2 about the rotary axis 6, the distance between the two sensor electrodes 8′ and 8″ changes, resulting in a signal that changes relative to the base signal.

The sensor mass 3 comprises different thicknesses in the direction of the Z-axis. While the sensor mass 2 comprises a thickness D to the left of the Y-axis, the thickness d is reduced to the right of the Y-axis, starting at the offset 5. The sensor mass 2 is thus thinner after the offset 5 in the direction of the X-axis than in the remaining area of the sensor mass 2. This results in a lower total mass to the right of the rotary axis 6, as compared to the thickness left of the rotary axis 6. For an acceleration in the Z-direction, therefore, the sensor mass 2 rotates counterclockwise about the rotary axis 6. The distance between the sensor electrodes 8′ and 8″ to the left of the rotary axis 6 is therefore reduced, while the distance between the sensor electrodes 8′ and 8″ to the right of the rotary axis increases. The corresponding change in the signal is detected by an analysis unit, not shown, and indicates an acceleration in the Z-direction.

As can be seen in FIG. 1, the sensor mass 2 has a plurality of holes 9. The holes 9 in this exemplary embodiment are distributed uniformly over the entire area of the sensor mass 2. FIG. 3 shows a magnified detail view of a cross section of the sensor mass 2 in the region of the offset 5 and the holes 9. From this representation, it is evident that holes 9′ are provided in the thicker region of the sensor mass 2 having the thickness D, while shorter holes 9″ are present in the thinner region after the offset 5 having a thickness d of the sensor mass 2. In the bottom region of the sensor mass 2, facing the substrate 7 and the sensor electrode 8′, no difference can be seen between the thicker and the thinner region of the sensor mass 2. The sensor electrode 8″ can be disposed accordingly, regardless of the change in mass of the sensor mass 2, on the bottom side of the sensor mass 2. The area required with respect to the projected area of the sensor mass 2 is thus equal on both sides of the rotary axis 6. This also applies to the hole pattern on the bottom of the sensor mass 9. Only the thickness of the sensor mass 2 varies in the Z-direction and on the top side of the sensor mass 2.

FIG. 4 shows an alternative exemplary embodiment of an acceleration sensor 1. The sensor mass 2 is fundamentally implemented just as described in FIGS. 1, 2, and 3. The difference is that a protrusion 10 is present to the right of the rotary axis 6, resulting from two offsets 5. In the region of the protrusion 10, the sensor mass has a large thickness D, while the sensor mass 2 has a lesser thickness d in the remaining areas. The holes disposed in the protrusion 10 and in the region of the offsets 5 are implemented just as shown in FIG. 3. The mass to the right of the rotary axis 6 is thereby greater than the mass to the left of the rotary axis 6. The sensor mass 2 will therefore undergo a clockwise rotation about the rotary axis 6 for an acceleration in the Z-direction. The distance between the sensor electrodes 8′ and 8″ to the right of the rotary axis 6 is therefore reduced, while the distance between the sensor electrodes 8′ and 8″ to the left of the rotary axis increases. A corresponding analysis of said electrical signals of the sensor electrodes 8′ and 8″ also leads to the result that an acceleration has occurred in the Z-direction.

The change in weight of the sensor mass in this exemplary embodiment has accordingly occurred in that material has been added to the sensor mass, and the holes present in this added material in the protrusion 10 have thereby been elongated.

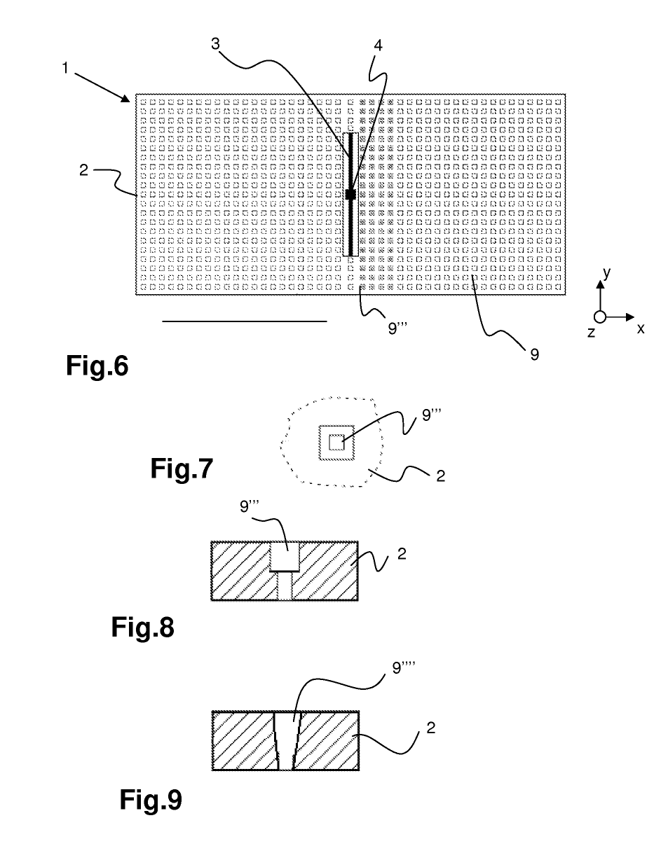

A different embodiment of the present invention by removing material is shown in the examplary embodiment of FIG. 6. Here again, this is fundamentally an acceleration sensor 1 as shown in FIG. 1 and FIG. 4. The difference here is that the thickness of the sensor mass 2 is the same everywhere. The mass change is achieved in that the individual holes are enlarged at the top side of the sensor mass 2, relative to the normal embodiment of the holes 9. This affects the holes disposed to the right of the rotary axis. The top sides of the holes 9′″ in the first four rows parallel to the Y-axis are enlarged.

FIG. 7 shows a magnified view of such an enlarged hole 9′″. The hole 9′″ has a square cross section. At the top side, the hole 9′″ has a greater edge length than at the bottom side.

FIG. 8 shows a cross section through a hole 9′″ according to FIG. 7. It is evident that the hole 9′″ is stepped. To about half of the thickness of the sensor mass 2, a greater edge length of the hole 9′″ is present that in the lower half of the sensor mass 2. The bottom side of the sensor mass 2 accordingly comprises the same hole pattern to the right of the rotary axis 6 as to the left of the rotary axis 6. The change relative to the hole 9 is made only on the top side of the sensor mass 2. It is thereby ensured, in turn, that a change in mass and therefore a change in weight of the sensor mass 2 is present to the left and right of the rotary axis 6. It is also ensured that, due to the identical hole pattern on the bottom side of the sensor mass 2 to the left and right of the rotary axis 6, the sensor elements advantageously provide identical output signals.

FIG. 9 shows an alternative to the hole shape from FIG. 8. The hole 9″″ shown here comprises a conical cross section. The advantage is once again thereby present that the mass and the weight of the sensor mass 2 can be affected by this measure, and the hole pattern on the bottom side of the sensor mass 2 for a corresponding analysis of the electrical signals of the sensor elements 8′ and 8″ is the same on both sides of the rotary axis 6.

The shape of the holes can also possibly have many different shapes, just as the design of the thickness of the sensor mass 2. It is also not mandatory that the hole pattern on the bottom side must necessarily be the same on both sides of rotary axis 6. The invention can also be implemented using a different hole pattern, although not entirely as advantageously. The holes can have round, square, rectangular, or other cross sectional shapes in the plan view. They can also change cross sectional shape over the thickness of the sensor mass 2. In cross section in the Z-direction, they can be implemented however the technical potential for production allows. For example, production of a stepped hole by using a plurality of silicone layers, or corresponding masking for the production process, particularly the etching process.

Sensor masses 2 according to the invention can also be disposed a plurality of times on a substrate. By accordingly selecting the projection area and arrangement of rotary axes to the orthogonal X-Y-Z system of axes, it is possible to detect accelerations not only in the Z-direction, as shown here, but also in the X-direction and/or the Y-direction.

The use of different hole shapes, whether in the length or the cross sectional shape, can also be used for acceleration sensors that not only rotate out of the X-Y plane, but also move within the X-Y plane, such as by rotary motion about the Z-axis. Such variations of the holes can also thereby lead to non-uniform mass distributions, and thus implement the corresponding advantages of the invention.

### REFERENCE LIST

1 MEMS acceleration sensor
2 Sensor mass
3 Spring
4 Anchor
5 Offset
6 Rotary axis
7 Substrate
8 Sensor element
9 Hole
10 Protrusion

1. An MEMS acceleration sensor, comprising:
a substrate;
a sensor mass that is disposed parallel to the substrate in an X-Y plane, the sensor mass being attached to the substrate that is rotatable about a rotary axis, the sensor mass comprising a plurality of holes, the weight of the sensor mass being different on the two sides of the rotary axis, the sensor mass including sensor elements for detecting a rotary motion of the sensor mass about the rotary axis; and
wherein in order to change the weight of the sensor mass on one side of the rotary axis relative to the other side of the rotary axis, material of the sensor mass is changed by at least one of the two methods including (a) partially removing material of the sensor mass in the region of some of the plurality of holes for reducing the weight of the sensor mass and (b) adding material of the sensor mass in the Z-direction in the extension of some of the plurality of holes for increasing the weight of the sensor mass.

2. The MEMS acceleration sensor according to claim 1, wherein the rotary axis is disposed symmetrically with respect to a projection surface of the sensor mass.

3. The MEMS acceleration sensor according to claim 1, wherein the plurality of holes are through holes.

4. The MEMS acceleration sensor according to claim 1, wherein some of the plurality of holes are stepped.

5. The MEMS acceleration sensor according to claim 1, wherein some of the plurality of holes are conical.

6. The MEMS acceleration sensor according to claim 1, wherein in method (a), the material of the sensor mass is at least partially removed on one side in order to produce a thinner wall of the sensor mass.

7. The MEMS acceleration sensor according to claim 1, wherein in method (b), the material is at least partially added to the sensor mass in order to produce a thicker wall of the sensor mass.

8. The MEMS acceleration sensor according to claim 1, wherein in method (b) and (a), the material is added to and removed from the side of the sensor mass facing away from the sensor elements, respectively.

9. The MEMS acceleration sensor according to claim 1, wherein in method (b) and (a), the material is added to and removed from outside the region of the sensor mass in which the sensor elements are disposed, respectively.

10. The MEMS acceleration sensor according to claim 1, wherein the sensor mass is rotatably mounted for sensing at least one rotation between rotations within and out of the X-Y plane.

11. The MEMS acceleration sensor according to claim 1, wherein the MEMS acceleration sensor comprises a plurality of sensor masses for detecting accelerations in a plurality of directions.
